(19) United States
(12) Patent Application Publication
(10) Pub. No.: US 2008/0098652 A1
(43) Pub. Date: May 1, 2008

(54) SPORT PLAYING FIELD

(76) Inventor: KENNETH THOMAS WEINBEL, KETCHUM, ID (US)

Correspondence Address: DYKAS, SHAVER & NIPPER, LLP, P.O. BOX 877, BOISE, ID, 83701-0877, US

(21) Appl. No.: 11/554,070

(22) Filed: Oct. 30, 2006

(51) Int. Cl. A01G 1/00

(52) U.S. Cl. 47/1.1 F

(57) ABSTRACT

An engineered turf management system utilizing a sand layer over a gravel layer, with irrigation by sub grade application of water and nutrients. A drainage system removes excess water, and an irrigation system applies water and nutrients to the bottom of the sand layer for distribution by capillary action.

### FIELD OF THE INVENTION

The invention generally relates to a system for managing a turf field for playing sports, and more particularly to an engineered turf field management system.

### BACKGROUND OF THE INVENTION

Over the years considerable concern has been given to the problems of sport playing fields identified by complaints from both player associations and facility managers. The current dissatisfaction with the state of the art synthetic grass fields and traditional natural grass fields is widely reported, worldwide.

Traditional natural grass fields require high maintenance for limited use. Compaction of the organic soil component of natural grass sport fields from player and maintenance equipment use inhibits grass plant growth and restricts drainage. Irrigation and fertilization by surface application produces short root growth creating a playing surface that lacks durable anchor and easily damaged from use.

Synthetic turf materials of nylon and polypropylene fibers tufted or knitted into a carpet backing have been used as a substitute for natural grass for increased play time year round. Synthetic turf has been manufactured as: carpets alone, synthetic carpets filled with rubber, synthetic carpets filled with sand, and synthetic carpets filled with a mixture of rubber and sand. Rubber in synthetic grass has been determined to create intense heat absorption, which presents danger to athletes as the field temperatures have been recorded as high as 165 degrees F. The sand used as infill in the popular synthetic grass is crystalline silica sand. In 1997, The International Agency for Research on Cancer (IARC), classified crystalline silica as a Group 1, human carcinogen—their highest risk rating. Synthetic sport turfs (placed in use to date) do not produce the safety and comfort that is provided by natural grass to the sport and recreation users.

Today with increased participation in field sports, and the discovery of the risk to users health from play on synthetic grass fields, there is clearly a need for a durable natural grass field. This invention is unique from prior inventions that did not succeed in their intended attempts to grow durable and safe natural grass fields. In addition the invention provides stable force reduction by eliminating soil compaction. The invention includes the option to regulate the actual force reduction properties of the natural grass sports field by the placement of a permeable synthetic force reduction foundation on an unbound permeable stabilized aggregate beneath the invention. The invention includes the option of constant temperature control of the grass plant root zone through a separate system of piping circulating temperature controlled fluid to heat the root zone by passive heat modulation.

Presently the natural grass sport sod fields used in retractable roof stadiums must be placed in portable trays that are moved in and out of the stadium to seek outdoor condition. To date, no stadium has successfully grown natural turf grass for extended periods in a completely enclosed stadium or retractable dome stadiums.

The natural turf management system invention provides the opportunity to sustain natural grass sod in a retractable roof stadium. The invention manages the moisture content and temperature at the subsurface root zone independent of the surface moisture and temperature, which allows for permanent installation of the natural grass. The loss of sunlight to the stadium floor field required for photosynthesis is overcome by the use of electrical lights and grass, which has a high tolerance to minimal sunlight exposure. This invention does not make claim to the use of electrical lighting to supplement natural light to grow indoor or outdoor natural sport turf, however the invention does point to the effectiveness of its use, when combined with the invention's root zone water and temperature management.

Although a number of variations exist, natural grass sports surfaces can generally be divided into a few major classifications. The traditional method has been the soil-turf field that uses organic soil as the growing medium. Later developments led to the modified-sand method that essentially replaces the soil in the classical field with a top layer of mixed organics and sand over an unmodified sand base.

Grassed sports playing surfaces have traditionally been installed using the soil-turf method that utilizes a surface crown for drainage run-off and at times, below grade piping systems for water removal. This method of construction and drainage combined with surface watering and fertilization techniques have produced surfaces that have always suffered from lack of adequate control of several factors. This has resulted in high maintenance costs and produces a gradual deterioration of the playing surface due to surface compaction and the subsequent inability to balance oxygen and purified moisture requirements to the plant.

These systems have grass that is shallow rooted (surface hugging) and which is easily damaged, slow to recover and requires increasing amounts of work and money for restoration as the surface ages, until major replacement is necessary. The grass does not stand up to more than minimal use and in wet locations the surface is consistently muddy due to the poor drainage ability. In dry locations the surface compaction and its reduction of the needed oxygen to the roots, produces a plant that quickly shows the effects of the heat and is not well nourished. Surface wear and tear is accelerated by these factors and player use, coupled with the effects of surface applied water which aggravates the compaction of the surface growing zone.

In cold climates soil warming techniques in soil turf fields are impractical since installation of a heating system will produce surface water from the melted frost and snow that has nowhere to go, thereby creating a muddy surface. Due to the compacted surface, the below grade drains are often ineffective.

The crown on the surface of soil-turf fields impairs its quality for player use and the surface sprinklers can be obstructions to be damaged by mowing equipment or vandals. Surface applied water is subject to higher evaporation losses and is affected by wind and its application can interfere with the use of the field. Applying water at preprogrammed times does not coincide with the continual transpiration losses of the plant. Impurities in the water supply are concentrated on the surface of the plant when the air borne water spray is subjected to evaporation losses that can result in damage to the grass surface.

The inadequacy of the soil-turf fields led to the development of the modified sand method, which is generally an attempt to overcome the drainage and compaction problems of soil-turf fields. Sand replaced the compactable soil and in order to avoid the drought condition at the surface-growing zone, a modified mix using sand and organics was graded over the sand. The modified surface zone was essential to retain the surface applied nutrients and moisture to support plant growth.

The modified turf fields suffer from lack of adequate control to ensure good quality growth over years of use. The surface zone, through normal decomposition of the organics, breaks down over time and leaches out into the drainage system, resulting in a non-uniform loss of water and nutrient retention characteristics which creates a drought condition and weakened plants. The decomposition of surface organics uses up nitrogen required by the grass for healthy growth. This built-in self-destruct component is not under the control of the maintenance personnel and eventually restoration of the entire surface zone is required.

The high water retention of the organic material at the surface creates a surface that is slippery after rainfall or irrigation and the plant is shallow rooted with minimal root penetration, and for this reason is easily damaged. Lateral movement of water is impaired in the sand causing larger head losses to reach the underlying piping system, which can cause surface puddling during heavy rain. The system cannot uniformly distribute below grade applied irrigation or fertilization and requires surface application techniques with the inherent disadvantages of surface water application as for the soil-turf method.

Soil warming techniques for sand bed fields in cold climate installations are impaired, as the system has no built-in ability to restore the moisture imbalance caused by the natural cold weather dehydration of the plant. Because of the high moisture retention characteristics of the surface organics, which is similar to the silt condition of the soil-turf fields, frost heave and surface ice problems are experienced.

Although the modified sand fields tend to perform on a limited but acceptable basis in the initial year or two, they tend to non-uniformly and uncontrollably break down after some years of use, thereby creating high maintenance costs. From the player's point of view, the addition of surface organics gives an undesirable spongy surface.

It has been demonstrated that a good quality natural grass field is the most desired surface. If it is level and unobstructed and handles adverse climatic conditions, it enhances the player's ability to play his sport. Grass turf requires maintenance to ensure vigorous growth using standard techniques in order to minimize the effects of wear and tear under use.

### SUMMARY

These disadvantages are overcome in the engineered turf management system of the invention. The components of the system can be adjusted to operation in a wide range of climatic conditions to be expected worldwide and to meet a particular location's construction material availability. The system of the invention is a controllable, all weather, natural grass sports and recreation surface that has the advantages of turf fields and has the engineering controls to solve the problems associated with turf fields.

The turf management system of the invention utilizes a principle that occurs naturally in some of the better and older golf greens and is usually found in coastal areas. That principle is a hydroponic growing zone created by a natural deposit of silty material overlaid by porous sand. The relatively impervious silt base temporarily maintains a sub-surface reservoir of water, which through capillary action inherent with the sand, rises to the surface to continuously irrigate the grass from below.

The system of the invention uses this principle in an engineered structure. By this method grass is grown via hydroponics with both sub-surface feed and irrigation of surface growing grass. The growth of the plant is maintained in a non-compactable and neutral medium that is isolated from the surrounding area by means of an impervious membrane below the sand layer.

The variable and unpredictable climatic factors acting upon the isolated surface are contained by the systems design and the undesirable excesses are compensated for by means of the controls and mechanical systems. These maintain the needed balance, within acceptable limits for the water, oxygen and nutrient requirements of the plant. The controls are positive and responsive and the balance provided ensures lush and rapid growth, which offers the immediate surface area with oxygen rich and resilient playing environment that is both firm and well cushioned.

The overall layout and configuration of the sport field varies according to the type of spots or recreational surface to be constructed. In all arrangements, the installation is divided into self-contained zones of a size to produce efficient control and yet maximize the economics of pipe lengths and spacing. These are optimized with the locally selected sand characteristics and its depth that are designed according to the location's climatic conditions.

Each section has a below ground valve station with a top flush to grade and which is located outside the isolated area so as not to impair the use of the field. A control system is provided to each of the individual zones. The control system monitors the liquid level within the zone and controls the liquid level within the zone by use of a valve station distanced from the field sufficient to allow unrestricted use of the field. From the control system the water level is monitored and water level information is relayed to the main control panel.

Each zone has a below ground valve station with the top flush to grade and which is located outside the isolated area so as not to impair the use of the field. A control system is provided to each of the individual sections, which transfers the liquid level within the isolated area to a point adjacent to the respective valve station where the water level is monitored and relayed to a main control panel.

The control room is nominal in size and is positioned remote to the field location that meets with the aesthetic value of the site. This room houses the main control panel, water supply header, liquid fertilizer/injection system, optional sub surface heating unit and circulation pumps. One small control room may service a number of playing areas.

The turf management system of the invention provides an isolated controlled growing environment with means to automatically handle subsurface drainage, irrigation and fertilization. The playing area is level and unobstructed and drainage is rapid, maintaining a dry and water free surface. The sub-surface application of water and nutrients are uniformly provided for on a continuous demand basis to the growing zone, as determined by both the plant and the climate. The grass plants are deep rooted and securely anchored. Since the grass is well nourished, it exhibits vigorous growth that ensures rapid self-repair characteristics, offsetting player wear and tear.

An optional feature is a root zone temperature control system, by which the playing surface can be maintained frost free or comfortably cool even in severe cold and hot surface air temperatures. Growth of the grass plant is encouraged by stable consistent root zone temperature. Without the inclusion of the root zone temperature control system and because of the materials and design employed, the frost and heat effects can be reduced, thereby naturally lengthening the period of usability by extending the growing season, since the system will accelerate and resist the longer freeze up and (or) heat/drought conditions.

An optional feature is a permeable synthetic force reduction foundation. This foundation allows for increased impact protection to users. The permeable synthetic force reduction foundation composition is infinitely variable solid or cellular elastomers bound by a polymer to provide the exact force reduction required for the safety of the intended users during the intended use. When the anti-compaction foundation is included in the turf management system a layer of permeable unbound stable aggregate is located under the permeable force reduction foundation. The hydroponic field's impermeable sealed membrane is placed directly on the permeable synthetic force reduction foundation creating a watertight barrier to vertical drainage from the hydroponic field into the force reduction foundation Horizontal and angular movement of water through the permeable synthetic force reduction layer is not impeded due to its permeable composition.

In order to provide this controlled environment, the field area is excavated and the sub-grade prepared to the required depth, and an impervious membrane is installed, completely isolating the area. Within the membrane-protected area, a horizontal liquid control system of perforated pipe and solid headers is placed directly on the impermeable membrane with the drain holes to be on the underside of the pipe. Selected granular material is placed against the pipe to substantially cover the drainage holes.

The perforated pipes are partially wrapped with filter cloth to prevent lines plugging of holes by silt and sand. At this point, over the selected granular material, a separate solid heating and cooling piping system of cross-linked polyethylene tubing (PEX) is placed for the optional root zone temperature control system. Over and around the pipes the sand is spread to a horizontal and level finished grade. The final operation consists of either placing off-site sand grown sod or spreading grass seed for grown-in turf. The seed mixture preferably uses several seed types and is suitably selected for the environmental conditions of the field's location and its ultimate use.

The section pipe mains from each valve station to the internal distribution system are located in a single trench below the membrane. The water level transfer tube is also located in the same trench. As the pipe verticals penetrate through the base of the impermeable membrane, they are wrapped and sealed.

Water introduced to the surface of a turf management system of the invention moves rapidly through the sand to the gravel layer. The sand layer has excellent vertical percolation capabilities while the gravel layer affords small resistance to lateral movement. Through the combination of the characteristics of both of these materials, an efficient drainage media is created which allows the water to move under minimal head losses to the properly spaced and sized perforated pipes.

Water added to the surface raises the internal water table of a zone, which then activates the level-sensing device when this level reaches the maximum design limit. Excess water not required for irrigation is then carried out the drainage pipes when signals from the level control unit initiate the opening of the automatic main discharge valves.

The selection of the sand and the gravel gradations is such that the sand will only nominally penetrate the gravel layer, a factor that is essential to avoid impairing the lateral flow values of the granular reservoir. The pipes are partially covered with filter cloth and tucked in at the bottom to prevent sand from entering the pipes. The manner employed leaves the pipe perforations open to the gravel and will not become plugged. To do so would require sand to first penetrate the gravel then move laterally and exit up into the pipes, a route that is restricted by the particular gradation selections of these materials.

The preferred drainage system is a gravity type. When properly engineered, it is the most economical means to handle extremely heavy rainfalls with no possibility of standing surface water. The capacity of the system and field reservoir is individually designed to accommodate the heaviest expected rainfall of the area. This prevents muddy conditions that would otherwise be detrimental to player use and aggravate plant damage.

The grass surface will undergo normal annual aeration and verticutting techniques to reduce the surface thatching. This is immediately followed by a light top dressing of sand to fill the voids created. This ensures the continued ability for rapid drainage through this surface layer.

Fertigation is the terminology used to describe the simultaneous application of fertilizer nutrients with the irrigation water. In the turf system of the invention this is provided for by the internally contained reservoir of nutrified liquid at the level of the gravel zone.

The natural capillary action of the sand continuously lifts the nutrified moisture to the plant's growing zone at a rate determined by the plant's needs and the effect of the climate on the surface. The gradation of the sand is selected to accommodate the maximum expected rates of transpiration for the particular location of the installation.

The losses of the subsurface reservoir are replaced by the periodic makeup of nutrified liquid through the action of the automatically controlled fertigation supply system. The gravel layer provides equal distribution throughout the field of the added liquid by its minimal resistance to lateral flow and allows the use of minimal line pressures to accomplish this essential uniformity. The injection of liquid fertilizer to the irrigation water is through a monitored injection pump.

The selection of proper sand size with the granular material is to produce a nominal penetration of sand into the gravel, insuring that the lowest water level is within the sand zone. Otherwise, capillary action from one level to another can be impaired. Under certain circumstances when the automatic system is not in use, the weir action of the pipe perforations sets the lowest water level, which is allowed to be above the drainage lines.

By means of the system's ability to continuously supply nutrified moisture to the plant at a low rate on a demand basis, the grass is well nourished and exhibits vigorous growth which greatly improves the turf self repair characteristics. The roots reach down directly toward the water table toward the higher water content gradient, without bunching towards the pipes, and thus are anchored securely, resisting any player tear out. It is an established fact that a grass supplied with nutrients and water at continuous low rates as in the invention is better able to withstand heavier traffic, and a healthy plant is more resistant to disease and infestation.

The turf management system of the invention offers the option of a soil temperature control system that will melt snow and remove frost as well as maintain a cool moist root zone during intense heat. The ability to provide a constant temperature at the root zone despite variance in surface temperature will thereby extend the usability of the grass-playing surface.

When heating systems are employed, it is required that they provide uniform and steady low temperature heat without resorting to the normal hot/cold cycling methods of control. The soil temperature must be low so there is no damage to the grass roots. The turf management system of the invention accomplishes the desired results by a combination of design methods. In one embodiment, the invention passively controls the temperature of the root zone by actively regulating the temperature of fluid inside plastic tubing placed directly on the gravel layer within the confines of the field system's sealed membrane. The liquid filled tubing passively heats or cools the water in the fan medium that the turf grass is rooted in. The passive temperature-controlling heater is significantly more energy efficient than present systems that use hydraulics to directly heat and/or cool subsurface soil. The invention provides a consistent root zone temperature in extreme playing surface temperatures whether the weather is hot or cool. As the temperature circulating fluid (which can be water or glycol) in this subsurface plastic tubing is raised, it heats the temperature of the water saturated sand drawing medium, which lies above and around the tubing until it evaporation occurs at the surface of the turf grass. The passive heating at the base of the sand layer will eventually melt snow on the surface as evaporation is maximized.

Conversely the same passive principle is used to cool the field. Cooling is achieved by actively circulating cold fluid through the plastic tubing, located at the base of the water saturated sand medium. The cold water saturated sand is heavier than the air above the turf grass so evaporation is contained to the surface thatched layer, which conserves moisture.

Surface water produced by the melted snow is rapidly handled by the systems drainage ability and the cold weather dehydration effect is compensated for by the continuous capillary action of moisture from the contained reservoir. Maximum temperatures are held below the tolerance level of the plant.

For fields installed with heating systems, an insulation layer is constructed immediately under the membrane, which at the periphery is carried down below the maximum affected depth of frost penetration. A perimeter trench using free draining granular fill and conventional drains is installed to isolate and protect the subgrade to the field. The effect of the insulation layer is to prevent the frost from penetrating into the subgrade when the heating system is not in use and to maximize its efficiency by directing the heat for surface use to remove snow.

For nonheated installations in cold climates, the insulation layer may be included to minimize frost penetration and eliminate subgrade heave problems. In these instances the system is entirely drained of all liquid while the plant remains dormant. Through this combination of design factors and without moisture present, the amount of frost is nominal, allowing for an early return to plant growth when air temperatures moderate, thereby extending the usable season.

### BRIEF DESCRIPTION OF THE DRAWINGS

FIG. 1 shows an example of a prior art turf management system.

FIG. 2 is an example of a prior art turf management system.

FIG. 3 is a cross sectional view of the turf management system of the invention.

FIG. 4 is a plan view of the turf management system of the invention.

FIG. 5 is a side cross sectional view of the turf management system of the invention with control system components.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

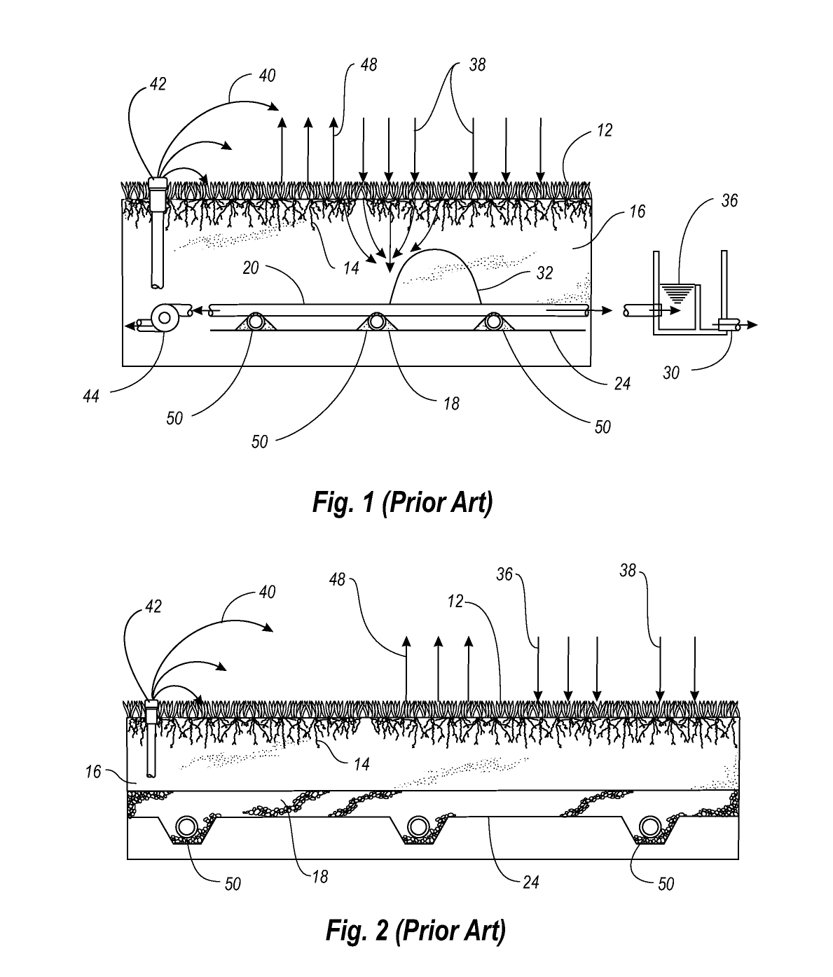

FIG. 1 is an example of a prior art playing field established with soil and turf and subsurface drainage. The grass 12 is shown growing at the surface level in soil that has become compacted and the roots 14 are shallow. The shallow roots result in the grass quickly showing the effects of heat and damage by sports activity, and makes the grass slow to heal. Irrigation water 40 is applied to the surface by a sprinkler 42, which impairs the quality of the playing surface. When the field is wet, it is muddy to play on, and when it is not wet the grass is suffering from lack of moisture. High evaporation, shown as 48, can cause a concentration and buildup of water-borne impurities at the surface of the soil. During periods of rain 38, the playing field is assisted in surface runoff by a crown, (not shown) but the crowning of the playing field presents problems in the use of the playing field, and the crowning is not enough to carry off heavier rainfalls. There is minimum drainage due to subsurface compaction of the soil below the grass. In periods of snow and frost, there is a high retention of moisture at the surface zone. This causes frost heaving and surface ice and with this system there is no snow removal capability built into the structure of the field. The grass and soil level would typically be about 6-12 inches thick, and could optionally have sub-surface irrigation including drainage pipes 20 and gravel 18, and a water removal pump 44. A weir drain 36 and perforated pipe 50 can be used with the intention of controlling the water table 32 via a drain line 30.

FIG. 2 shows an example of another prior art sport field irrigation system. At the surface, grass 12 is growing, with its roots 14 embedded in a modified surface zone that is made of sand 12 and organics at the surface. The sand and organics layer would typically be four inches thick. Below the sand and organics layer is a deeper layer made of sand 16. This would typically be approximately 8 inches deep. Below the sand is a water impervious membrane 24. This membrane prevents the flow of moisture into the deeper areas of the soil. The grass on the surface is irrigated by sprinkler heads 42 that are positioned at the surface of the ground and spray water 40 on to the top of the grass and the top layer of the soil. Water that percolates through the top layer sand and organics can also percolate through the sand layer and collect above the membrane 24. Above the membrane is a gravel layer and drainage pipes 50 that have holes so that water may enter the drainage pipe and be carried away. A pump (not shown) can be made available to help move the water from the above membrane away from the field. Problems with this type sport field include the buildup of water-borne impurities at the surface of the ground due to high evaporation 48. Another problem is that when rain 36 is experienced by a system such as this, the removal of rainwater is impeded by the sand layer and causes the hydraulic curve on water table to intercept the surface of the ground and create puddles. Also during periods of snow and frost, the high moisture retention of the organic containing layer at the surface causes a slippery condition when the surface is wet, and contributes to frost heave and ice problems. Additionally, the draining pipe is typically routed through a weir (not shown) that is established to control the water level. The weir is not particularly responsive to the needs of the grass layer for growth and contributes to the problems described above.

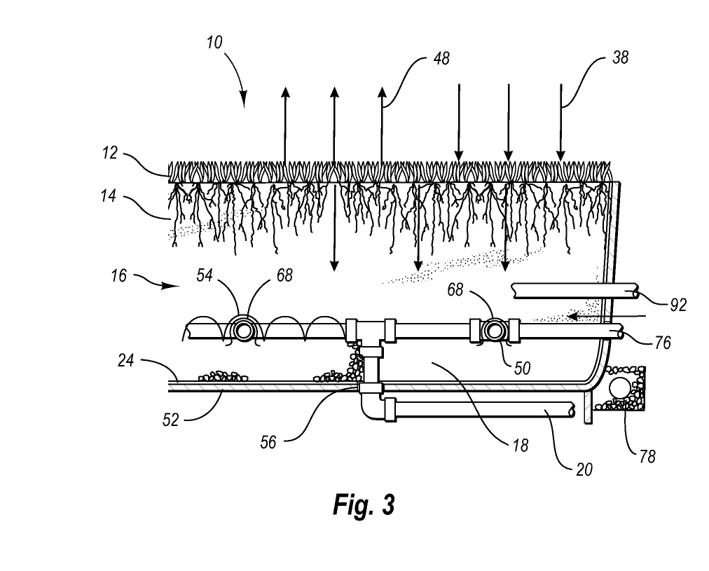

FIG. 3 shows the turf management system of the invention, which is designated as 10 in the drawings. Unlike the prior art, water is not applied through sprinklers located at the surface. As in the prior art, water can enter the field from rainwater or snow, which is shown as 38. Water also evaporates from the field, which is shown as 48. The field includes a layer of grass 12 with roots 14. Roots 14 grow to a much greater depth than in the prior art systems because they are growing towards the water gradient. The subsurface material is moister than the surface materials. Therefore, the roots grow in the direction of greater moisture and become much more sturdy and deeply rooted. Having a more extensive root system also makes the grass 12 more resilient to damage and faster to heal. The grass 12 is grown in a matrix of sand 16. The sand extends from the surface to a layer of gravel 18 on which is placed the drainage system that includes perforated pipe 50, a drainpipe 20 and a fill line 76. Below the gravel layer 18 is a water impermeable membrane 24. Depending on the climate, an insulation layer 52 can be below and around the membrane 24.

Water and nutrients are applied through the fill line 76 and fill the gravel layer 18, which acts as a water reservoir. Perforated pipes 50 are covered by a filter cloth 68 to prevent sand or gravel from entering the drainpipe 20. Where an electric heating system is in place, the heating cable 54 can be placed around or above the drain line 20 and heated to an extent to allow water to drain through the sand, but to not break the dormancy of the grass. The piping system can also be used as a passive heat transfer system, and thus the heating cable would be eliminated. With this kind of a system, rainwater 38 can quickly percolate through the grass and sand layer because it is unimpeded by organic material. Irrigation water travels from the gravel layer 18 into the sand layer 16 and moves towards the surface by capillary action. Thus, the moisture gradient is moister towards the gravel layer and less moist at the surface layer. It is this moisture gradient that causes the roots of the grass to grow deeper, just as they would in nature. Since there is no organic material at the surface, the turf management system of the invention does not compact at the surface and lead to a layer that impedes percolation of rainwater. Thus, standing pools of water are eliminated by improved drainage. Where there are pipe penetrations through the membrane in the insulation, these penetrations are sealed with a seal 56 around the pipe so that water from inside the system does not leak out into the subsoil. A perimeter drainage system 78 that includes a drain line 30 and gravel 18, can be installed around the perimeter of the field in order to remove water that may pool against the outside of the membrane 24.

The configuration of the components of the turf system 10 would be tailored to the specifics of the climate of a particular area. By way of example, and not presented as a way to limit the designed parameters of a typical system, the turf layer could be approximately 1.5 inches thick, with roots extending into the sand layer, which is 15 inches from the surface to interface with the gravel layer. The gravel layer would be approximately 4 inches thick. The impermeable membrane 24 could be 6 millimeters (or greater) in thickness. A preferred material for the impermeable membrane is polyethylene sheeting. The installation layer 52 can be made of a number of materials, but one material, which has been found to be suitable, is expanded polypropylene (EPP) and might be used in some installations in a thickness of 1 inch.

The drainage system can also be configured dependent upon the size and weather of a particular installation. Some configurations that are representative examples would include a perforated pipe that is made of poly vinyl chloride (PVC) and is 3 inches in diameter with perforations that are 1 inch in diameter. The fill line 76 might be constructed to be 4 inches in diameter, made of poly vinyl chloride (PVC). The drain line 20 could be 3 inches in diameter and made of poly vinyl chloride (PVC). The drain line 78 could be 10 inches in diameter.

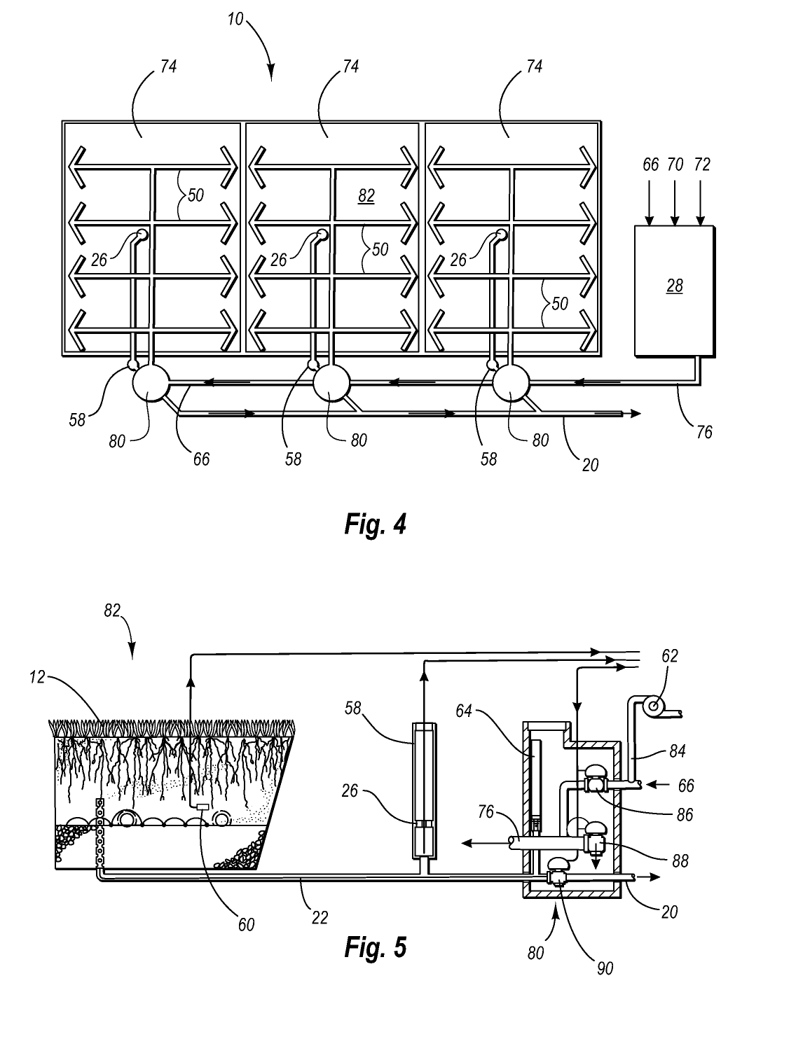

FIG. 4 shows a plan view with a general layout of the turf management system pan of the invention. A sports playing field is divided into zones 74, with each zone 74 having a separate valve station 80, level control unit 58, water level sensor 26, drain lines 20 and perforated pipe sections 50. Water drained from the system exits by way of the drain line 20. Water and fertilizer enter the system by way of fill line 76 and valve station 80.

FIG. 5 shows more detail of the interaction between the playing field 82 and the valve station 80. This system includes a water level tube 22 that extends into the playing field and rises through the gravel level some distance into the sand level. The water level tube 22 is perforated inside the playing field 82, and where it penetrates the membrane 24, and is sealed against leakage of water through the membrane. The water level tube 22 is also covered by filter cloth 68 to prevent sand or gravel from entering the pipe or plugging the perforations.

The water level tube 22 is connected to a level control unit 58 that includes a water level sensor 26. The water level in playing field 82, is reflected by standing water in the level control unit 58, which is sensed by the water level sensor 26. A signal is sent from the water level 26 to the control station 28 to either send fill water and fertilizer to the playing field 82, or to open the drain line 30 to drain water from the field. The valve station 80 includes a fertilizer injection pump 62 with an associated storage and mixing tank (not shown). Incoming water enters the control station 28 or the valve station 80 and is indicated by 66 in FIGS. 4 and 5. The incoming water mixes with the fertilizer after feed pipe 84 and carries the mixture into the fill line 76.

An optional control scheme can include a safety measure so that when the water level sensor 26 senses that water is needed, the signal from the water level sensor not only opens a water feed valve 86, but also ensures that the water drain valve 88 and 90 are closed. Similarly if the water level sensor 26 indicates that there is an excess of water in the playing field 82, a signal from the water level sensor not only opens the water drain valve 88 and the second water drain valve 90, but also ensures that the water fill valve 86 and the fertilizer injection pump 62 are turned off.

Within the external water level sensing unit 58, atmospheric pressure rises or falls in response to the water level within the field. This float, without moving parts, magnetically transmits through a low voltage electrical signal to the control panel the data needed to activate the automatic valves to either remove or add liquid to the system. These valves are operated by pressure taken from the irrigation supply line, which is activated by another low voltage signal to a solenoid on these bleed lines located within each valve station. This method enhances the safety of the system by eliminating the need to transmit electrical power to the field area. Visual inspection of the water level is provided by means of a sight tube in the valve station 80.

A computer directed master control panel has programmable functions, which can sequence operations to minimize demand loads on the irrigation, drainage, fertigation, heating, and cooling systems. A specifically authored software program directs the master control panel via wireless, coaxial, or telephone cable, enabling off site real time monitoring of and control systems functions. Data for assessment of system function and maintenance program is by default, saved by the software program. The software program includes a malfunction alert system that provides instant alert to facility staff via wireless network.

Incorporated in the water level sensing units can be included an automatic means to periodically record the liquid reservoir's nutrient condition and check the field's pH values. Corrections can be made through the fertigation system, and if a chemically uncorrectable imbalance occurs, then the transfer tube can also function as a drain to completely empty the field, allowing a purging cycle to take place to neutralize the system. Likewise a real time temperature monitor unit can be incorporated in the water sensing level units. Root zone temperature can be raised or lowered via the master control panel, which directs the heating system to operate or remain on stand by. Introduction of cold water to the hydroponic base will force warm water to be removed from the overflow valves to retain the optimal temperature in the root zone. Since the temperature of the root zone is heated and cooled passively the grass plant feels no change in the root zone even when alternating from cooling during the sunlight ours to heating without sunlight. This feature is especially effective in growing healthy natural turf in part-time indoor stadiums with retractable roofs.

The turf management system of the invention within the growing area uses completely passive components and systems. Gravity and surface tension acting on the sand particles are doing all the work. The integrated control and valve units, while employing moving and functioning components, are only required for make-up operations. Consequently, an unexpected malfunction does not impede the immediate needs of a quality grass surface since reasonable time is available and manual overrides are provided to allow maintenance to conveniently remedy the adjustment.

A permeable synthetic force reduction foundation may be placed upon a level base comprised of stable unbound mineral aggregate prior to the installation of the impermeable membrane. The composition and thickness of the permeable synthetic force reduction foundation is infinitely variable to achieve proper impact reduction for the desired activity use of the field. The permeable synthetic foundation provides correct deformation and return in both the vertical and modified vertical force angles as to not impede the propulsion of the athlete off the natural grass surface of the invention. The permeable synthetic force reduction foundation provides additional safety to players from impact with the playing surface. The impermeable sealed membrane is place directly upon the permeable synthetic force reduction foundation to block the flow of sand and (or) organic matter from the natural grass field placed upon it that could impede water flow through the permeable synthetic force reduction foundation and restrict drainage.

A basic concept incorporated in the criteria of the design for the turf management system of the invention is flexibility. Flexibility as to the system's arrangement and configuration; flexibility in order to accommodate the peculiar climatic environment of any world location, and flexibility as intended to serve its end application.

The system layout for a particular application can be varied to work optimally for the desired use. Specific use sport type fields, multiuse sports type fields, horse racing tracks and courses, urban park recreation areas, or even an unsymmetrical golf green. The arrangement of the piping systems can be repositioned to suit the required surface area and ancillary valve stations. The control room can be situated to match the practicality of the installation or the esthetic requirements of the site. Irregularity to the surface can be superimposed into the design when desired by its use.

The design parameters can be varied to accommodate either dry or wet locations and cold or hot environments. Piping systems can be engineered as essentially irrigation conduits or the design weight can be directed towards drainage needs or a combination of both can be handled. The availability of a particular location's sand can be dealt with by adjusting field depth and pipe spacing while tying these to the effects imposed by climate. In all climates, the temperature of the subsurface water filled sand medium can be regulated constantly, to provide optimum growth temperature range in the root zone of the grass plant as desired.

The intended use of the grass surface can be accommodated by adjusting the configuration of the system and by selection of the appropriate grass seed mix. A turf management system of the invention can be used for football fields, soccer pitches, baseball parks, golf greens, golf courses, horse race tracks' turf courses, horse steeple courses, tennis courts, and multipurpose park and school recreation areas. In fact, controlled by the evaluation of the economics involved, a turf management system of the invention can be utilized for any sports, recreational or other surface, which demands a heavy growth of natural grass.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention, which is measured by the claims, nor is it intended to be limiting as to the scope of the invention in any way.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An engineered turf management system for managing a playing field, comprising:
a hydroponic turf bed extending from ground level to a sub grade interface, comprised of a sand layer, a turf grass layer, with said turf grass layer at ground level and comprised of living turf growing in sand, and a gravel layer below said sand layer;
a waterproof membrane underlying said gravel layer of said hydroponic turf bed;
a water level control system comprising;
a water application system that delivers irrigation water to said sand layer via subsurface pipes, with said water application system further including a fertilizer injection station;
a water removal system for removing excess water from said turf bed; and
a water level sensor for determining the height of a water table in the hydroponic turf bed.

2. The engineered turf management system of claim 1 in which said water application system comprises a system of transfer pipes and perforated water distribution pipes, with said water distribution pipes positioned at or below an interface between said sand and said gravel layers.

3. The engineered turf management system of claim 2 in which said transfer pipes are located below said membrane and said water distribution pipes are positioned above said membrane.

4. The engineered turf management system of claim 3 in which said distribution pipes are connected to said transfer pipe by risers that penetrate said membrane, with said membrane sealed around said vertical risers where penetrations occur.

5. The engineered turf management system of claim 1 in which said water removal system comprises one or more drain pipes connected to perforated water inlet pipes, and said perforated water inlet pipes extend from a position below said sand and gravel interface to said drain pipes located below said water inlet pipes.

6. The engineered turf management system of claim 1 in which said water level system further comprises a generally U-shaped water level tube with a first end positioned in said sand layer of said turf bed, and a second end located in a water level control unit and said second end configured to reflect the height of the water table in said turf bed.

7. The engineered turf management system of claim 6 in which said water level control system is positioned a sufficient distance from said turf bed to allow unhindered use of said turf bed.

8. The engineered turf management system of claim 7 in which said water level control system further includes a water level sensor for sensing when said water level reaches a predetermined maximum level, and for activating one or more water draining mechanisms at said maximum height.

9. The engineered turf management system of claim 8 in which said water level sensor activates at least one drain valve when said maximum water table level is reached.

10. The engineered turf management system of claim 9 in which said water level sensor activates at least one water drain pump in addition to at least said one drain valve when said maximum water table level is reached.

11. The engineered turf management system of claim 9 in which said water level sensor further deactivates a water delivery valve when said drain valve is activated.

12. The engineered turf management system of claim 8 in which said water level control system includes a water level sensor for sensing when said water level reaches a predetermined minimum water table level and a nominal water table level, and for activating one or more water filling mechanisms at said minimum water table level, and for deactivating said water filling mechanisms when a nominal water table level is reached.

13. The engineered turf management system of claim 12 in which said water level sensor activates a fill valve when said minimum water table level is reached; and also deactivates said fill valve when said nominal water table level is reached.

14. The engineered turf management system of claim 13 in which said water level sensor further deactivates a water drain valve when said water table sensor indicates a water table between said minimum and said nominal height.

15. The engineered turf management system of claim 1 in which said playing field is divided into zones, with each zone being monitored, irrigated, drained, and otherwise controlled separately, with parameters of each of said zones displayed in a control station.

16. The engineered turf management system of claim 1 which further includes an insulation layer adjacent to said waterproof membrane, for thermal isolation of said hydroponic turf bed from the surrounding substrate.

17. An engineered turf management system for managing a playing field, comprising:
a hydroponic turf bed extending from ground level to a sub grade interface, comprised of a sand layer, a turf grass layer, with said turf grass layer at ground level and comprised of living turf growing in sand, and a gravel layer below said sand layer;
a waterproof membrane underlying said gravel layer of said hydroponic turf bed;
a water level control system comprising a plurality of zones in said playing field, with each zone comprising;
a generally U-shaped water level tube with a first end positioned in said sand layer of said hydroponic turf bed, and a second end located in a water level control unit with said second end configured to reflect the height of a water table in said turf bed;
a water level sensor for determining the height of a water table in the hydroponic turf bed by sensing the water level in said second end of said U-shaped tube;
with water level sensor configured for activating one or more water filling valves at said minimum, water table level, and for deactivating said water filling mechanisms when a nominal water table level is reached, and for activating one or more water draining valves at a maximum water table level, and for deactivating said draining valves at a nominal water table level
a water application system that delivers irrigation water to said sand layer via subsurface pipes, including transfer pipes connected to perforated water distribution pipes, with said water distribution pipes positioned at or below an interface between said sand and said gravel layers with said water application system further including a fertilizer injection station
a water removal system which comprises one or more drain pipes connected to perforated water inlet pipes, for conducting water from said hydroponic turf bed.

18. The engineered turf management system of claim 17 which further includes a heat management system comprising a system for subsurface pipes for heat controlled liquid for heat transfer by convection and conduction to said hydroponic turf bed.

19. The engineered turf management system of claim 17 which further includes a heat management system comprising a grid of subsurface heating cable for adding heat to said hydroponic turf bed.

20. The engineered turf management system of claim 1, which further includes a force reduction foundation, configured to moderate impact force from the field surface, positioned below said impermeable membrane.
